(19) United States
(12) Patent Application Publication
(10) Pub. No.: US 2017/0199694 A1
(43) Pub. Date: Jul. 13, 2017

(54) SYSTEMS AND METHODS FOR DYNAMIC STORAGE ALLOCATION AMONG STORAGE SERVERS

(71) Applicant: Dell Products L.P., Round Rock, TX (US)

(72) Inventors: Lucky Pratap Khemani, Bangalore (IN); Shekar Babu Suryanarayana, Bangalore (IN)

(73) Assignee: Dell Products L.P., Round Rock, TX (US)

(21) Appl. No.: 14/990,499

(22) Filed: Jan. 7, 2016

(51) Int. Cl. G06F 3/06

(52) U.S. Cl. CPC G06F 3/0631; G06F 3/0607; G06F 3/0689

(57) ABSTRACT

In accordance with embodiments of the present disclosure, an information handling system may include a plurality of physical storage resources and a storage controller associated with the storage resources. The storage controller may be configured to allocate a reserved portion of each of the plurality of physical storage resources to a local pool reserved storage associated with the storage controller, communicate to at least one other storage controller information regarding the local pool reserved storage, and receive from the at least one other storage controller information regarding a global pool reserved storage comprising the local pool reserved storage and at least one other local pool reserved storage of the at least one other storage controller.

### TECHNICAL FIELD

The present disclosure relates in general to information handling systems, and more particularly to intelligent allocation of storage among storage resources of storage servers.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many computing applications, information handling systems store massive amounts of data. In certain instances, an operating system may require storage space beyond that allocated to the operating system. To provide such additional storage using traditional approaches, additional physical storage resources may need to be added to an information handling system, which may increase cost, power consumption, cooling requirements, and physical space needed to accommodate the additional storage.

### SUMMARY

In accordance with the teachings of the present disclosure, the disadvantages and problems associated with existing approaches to storage allocation may be reduced or eliminated.

In accordance with embodiments of the present disclosure, an information handling system may include a plurality of physical storage resources and a storage controller associated with the storage resources. The storage controller may be configured to allocate a reserved portion of each of the plurality of physical storage resources to a local pool reserved storage associated with the storage controller, communicate to at least one other storage controller information regarding the local pool reserved storage, and receive from the at least one other storage controller information regarding a global pool reserved storage comprising the local pool reserved storage and at least one other local pool reserved storage of the at least one other storage controller.

In accordance with these and other embodiments of the present disclosure, a method may include allocating a reserved portion of each of a plurality of physical storage resources of an information handling system to a local pool reserved storage associated with a storage controller of the information handling system, communicating to at least one other storage controller information regarding the local pool reserved storage, and receiving from the at least one other storage controller information regarding a global pool reserved storage comprising the local pool reserved storage and at least one other local pool reserved storage of the at least one other storage controller.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: allocate a reserved portion of each of a plurality of physical storage resources of an information handling system to a local pool reserved storage associated with a storage controller of the information handling system, communicate to at least one other storage controller information regarding the local pool reserved storage, and receive from the at least one other storage controller information regarding a global pool reserved storage comprising the local pool reserved storage and at least one other local pool reserved storage of the at least one other storage controller.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of a system of a plurality of information handling systems, in accordance with embodiments of the present disclosure;

FIG. 2 illustrates a block diagram of allocation of storage capacity of storage resources to local pool reserved storage and global pool reserved storage, in accordance with embodiments of the present disclosure;

FIG. 3 illustrates a flow chart of an example method for performing an input/output operation, in accordance with embodiments of the present disclosure;

FIG. 4 illustrates a flow chart of an example method for allocating local pool reserved storage and global pool reserved storage based on monitoring input/output requirements, in accordance with embodiments of the present disclosure; and

FIG. 5 illustrates a block diagram of a system of a plurality of information handling systems in a converged architecture, in accordance with embodiments of the present disclosure.

### DETAILED DESCRIPTION

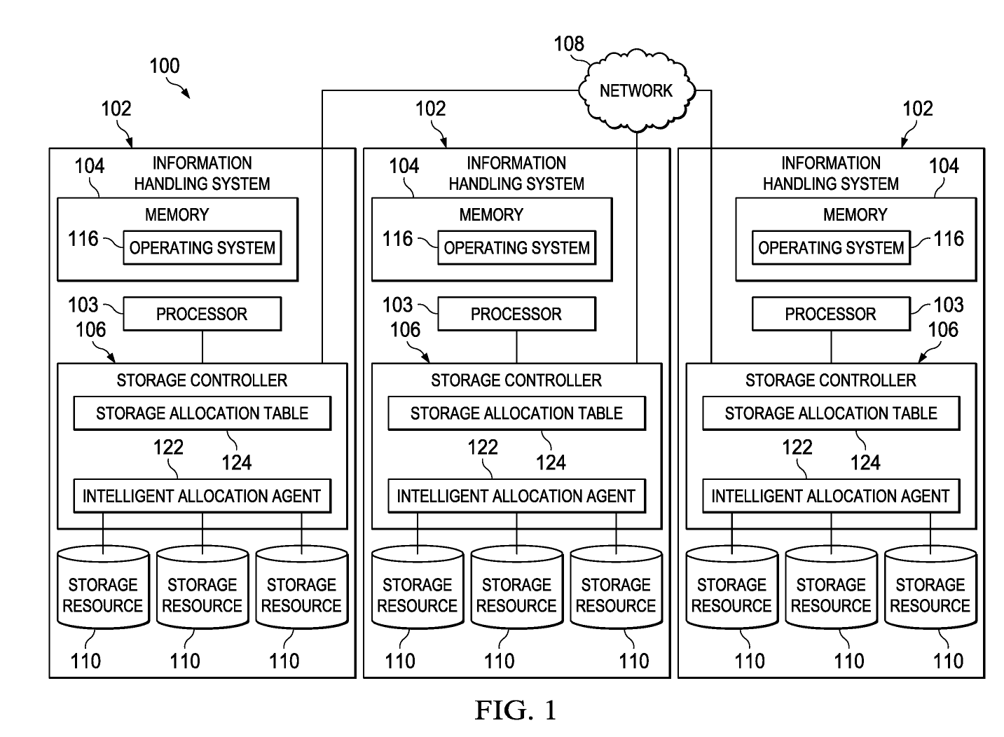

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

As used herein, the term “local” may refer to components of an information handling system while the term “remote” when used in connection with a component may refer to a component of another information handling system.

FIG. 1 illustrates a block diagram of a system 100 of information handling system 102, in accordance with embodiments of the present disclosure. As shown in FIG. 1, system 100 may include a plurality of information handling systems 102. In some embodiments, an information handling system 102 may comprise a server. As depicted in FIG. 1, an information handling system 102 may include a processor 103, a memory 104 communicatively coupled to processor 103, a storage controller 106 communicatively coupled to processor 103, and a plurality of physical storage resources 110 communicatively coupled to storage controller 106.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource 110, and/or another component of information handling system 102.

A memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 116. Operating system 116 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 116. Active portions of operating system 116 may be transferred to memory 104 for execution by processor 103. Although operating system 116 is shown in FIG. 1 as stored in memory 104, in some embodiments operating system 116 may be stored in storage media accessible to processor 103 (e.g., storage resource 110), and active portions of operating system 116 may be transferred from such storage media to memory 104 for execution by processor 103.

Storage controller 106 may include any system, apparatus, or device operable to manage the communication of data between processor 103 and storage resource 110. In certain embodiments, storage controller 106 may provide functionality including, without limitation, disk aggregation and redundancy (e.g., RAID), I/O routing, and error detection and recovery. Storage controller 106 may also have features supporting shared storage and high availability. In some embodiments, storage controller 106 may comprise a PowerEdge RAID Controller (PERC) manufactured by Dell Inc.

As shown in FIG. 1, storage controller 106 may comprise an intelligent allocation agent 122. Intelligent allocation agent 122 may comprise any suitable system, device, or apparatus configured to dynamically allocate storage of storage resources among operating systems 116 of information handling systems 102 by maintaining a global pool of storage that may be allocated to any of information handling systems 102, and to predict usage of storage capacity by information handling systems 102 in order to allocate such global pool, as described in greater detail below. In these and other embodiments, intelligent allocation agent 122 may also implement a communication protocol for communicating with intelligent allocation agents 122 of other information handling systems 102, in order to carry out the allocation functionality described herein. In some embodiments, intelligent allocation agent 122 may be embodied in a program of instructions (e.g., firmware or software) which may be read and executed by control logic of storage controller 106.

As shown in FIG. 1, storage controller 106 may have stored thereon storage allocation table 124. Storage allocation table 124 may comprise any suitable data structure setting forth metadata or other information regarding allocation of storage and data stored on storage resources 110 (e.g., logical block addresses of stored data, disk and sector information corresponding to logical block addresses, etc.).

A storage resource 110 may include one or more hard disk drives, magnetic tape libraries, optical disk drives, magneto-optical disk drives, compact disk drives, compact disk arrays, disk array controllers, and/or any other system, apparatus or device operable to store media. In some embodiments, storage controller 106 may form a virtual storage resource utilizing one or more of storage resources 110 such that the virtual storage resource may appear to an operating system or virtual machine executing on information handling system 102 as a single logical storage unit or virtual storage resource. For example, such a virtual storage resource may comprise a RAID. Thus, in some embodiments, a virtual storage resource may comprise a redundant array of physical storage resources. In the same or alternative embodiments, a virtual storage resource may be implemented using a RAID standard. Although FIG. 1 depicts storage resources 110 internal to information handling system 102, in some embodiments, storage resources 110 may be external to information handling system 102 (e.g., embodied by a physical array of external hard disk drives).

In addition to processor 103, memory 104, storage controller 106, and storage resource 110, information handling system 102 may include one or more other information handling resources. For example, although FIG. 1 depicts each information handling system 102 having three storage resources 110, an information handling system 102 may include any suitable number of storage resources 110.

Network 108 may be a network and/or fabric configured to couple information handling systems 102 to each other. In some embodiments, network 108 may include a communication infrastructure, which provides physical connections, and a management layer, which organizes the physical connections and information handling systems communicatively coupled to network 108. Network 108 may be implemented as, or may be a part of, a storage area network (SAN), a PAN, a LAN, a metropolitan area network (MAN), a WAN, a wireless local area network (WLAN), a virtual private network (VPN), an intranet, the Internet or any other appropriate architecture or system that facilitates the communication of signals, data and/or messages (generally referred to as data). Network 108 may transmit data using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 108 and its various components may be implemented using hardware, software, or any combination thereof.

As shown in FIG. 1, storage controllers 106 may be coupled to one another via network 108. In some embodiments, each storage controller 106 may include a network interface (e.g., network interface card) for communicating via network 108. In other embodiments, information handling systems 102 may comprise network interfaces separate from storage controllers 106 for enabling such communication.

In addition to information handling systems 102 and network 108, system 100 may include one or more other information handling resources. For example, although FIG. 1 depicts system 100 having three information handling systems 102, system 100 may include any suitable number of information handling systems 102.

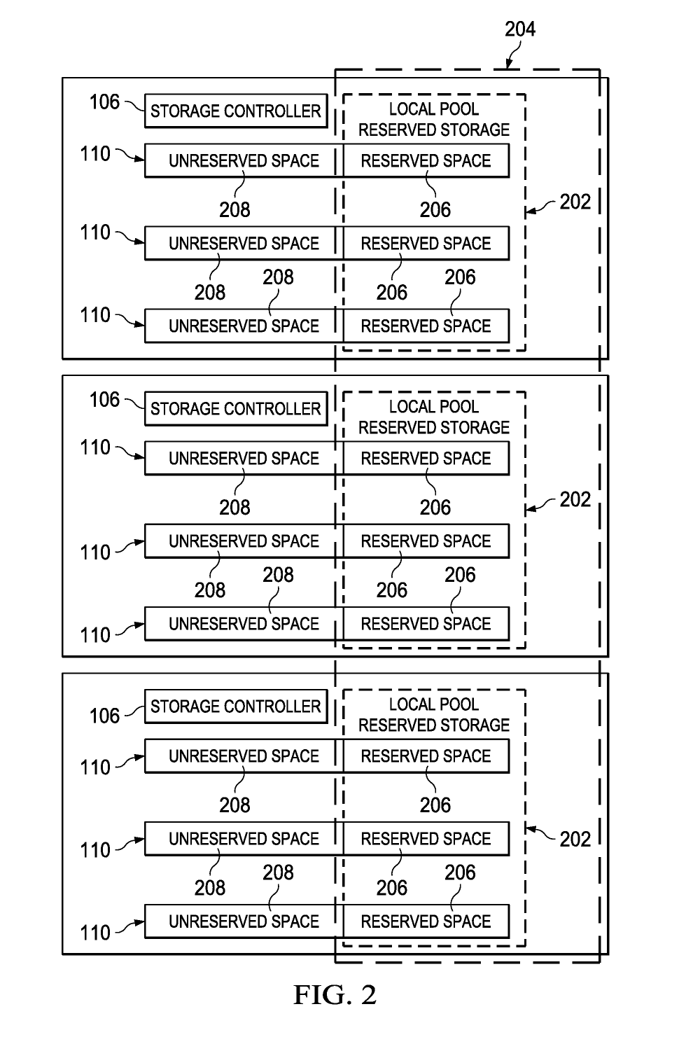

FIG. 2 illustrates a block diagram of allocation of storage capacity of storage resources 106 to local pool reserved storage 202 and global pool reserved storage 204, in accordance with embodiments of the present disclosure. As shown in FIG. 2, an intelligent allocation agent 122 of an information handling system 102 may maintain for each storage resource 110 controlled by a storage controller 106 a reserved space 206. Such reserved space 206 may initially be allocated by an administrator or other user, and as described below, such reserved space 206 may change in size based on demands of an operating system 116 executed on an information handling system 102 comprising such storage controller 106. The remaining unreserved space 208 may be allocated by a storage controller 106 to an operating system 116 as local storage for its storage requirements, and may be used by a storage controller 106 local to the storage resources 110 to instantiate one or more virtual storage resources for storing data of the local operating system 116. Reserved space 206 may be visible to a storage controller 106 local to reserved space 206 but may not be visible to an operating system 116.

The reserved space within an information handling system 102 may be referred to as such information handling system's local pool reserved storage 202, and the aggregate of local pool reserved storage 202 in system 100 may be referred to as the system's global pool reserved storage 204. Each storage controller 106 may be configured to maintain within storage allocation table 124 the range of physical storage addresses within its associated local pool reserved storage 202 and communicate such information to other storage controllers 106. Based on information communicated among storage controllers 106 regarding the local pool reserved storage 202, each storage controller 106 may also maintain in storage allocation table 124 information regarding global pool reserved storage 204. In addition, a storage controller 106 may also maintain metadata within storage allocation table 124 which may point to data that a storage controller 106 stores to a portion of global pool reserved storage 204 physically located within another information handling system 102 (as is described in greater detail below). Furthermore, a storage controller 106 may also maintain information identifying a unique identifier for each storage controller 106 in system 100 with information (e.g., physical storage ranges) regarding the respective local pool reserved storage 202 associated with storage controller 106.

In operation, whenever an operating system 116 requests more storage capacity than it has been initially allocated (e.g., within unreserved space 208 of local storage resources 110), the intelligent allocation agent 122 local to such operating system 116 may first check availability of storage space in the local pool reserved storage 202 local to the intelligent allocation agent 122. If space is available in the local pool reserved storage 202, then the intelligent allocation agent 122 may enable input/output operations to the local pool reserved storage 202. In some embodiments, the intelligent allocation agent 122 may cause its local storage controller 106 to instantiate a virtual storage resource from the local pool reserved storage 202 spanning two or more storage resources 110. Intelligent allocation agent 122 may also maintain logical block address information of the data stored to local pool reserved storage 202 and physical storage address information (e.g., disk and sector) associated with such logical block address. Once the input/output operation is completed, intelligent allocation agent 122 may update sizes of local pool reserved storage 202 and global pool reserved storage 204 and communicate such information to other remote storage controllers 106, such that any new storage requests may be served based on such updated sizes.

If space is available in the local pool reserved storage 202, then the intelligent allocation agent 122 may determine availability of storage space in the global pool reserved storage 204. If space is available in global pool reserved storage 204, then the intelligent allocation agent 122 may enable input/output operations to the global pool reserved storage 204. In some embodiments, such input/output operations may be directed to a single local pool reserved storage 202 of another remote storage controller 106. In some of such embodiments, preference may be given for allocation to local pool reserved storage 202 of a remote storage controller 106 that is most physically proximate to the storage controller 106 of the operating system 116 performing the input/output operation. Intelligent allocation agent 122 may also maintain logical block address information of the data stored to global pool reserved storage 204 and physical storage address information (e.g., storage controller identifier, disk, and sector) associated with such logical block address in global pool reserved storage 204. Once the input/output operation is completed, intelligent allocation agent 122 may update sizes of local pool reserved storage 202 and global pool reserved storage 204 and communicate such information to other remote storage controllers 106, such that any new storage requests may be served based on such updated sizes.

In addition, in some embodiments, intelligent allocation agent 122 may monitor storage capacity usage of a local operating system 116 and based thereon, predict storage requirements of a local operating system 116 and maintain the size of a local pool reserved storage 202 based thereon. If changing the size of a local pool reserved storage 202, intelligent allocation agent 122 may communicate such information to other remote storage controllers 106, such that any new storage requests may be served based on such updated sizes.

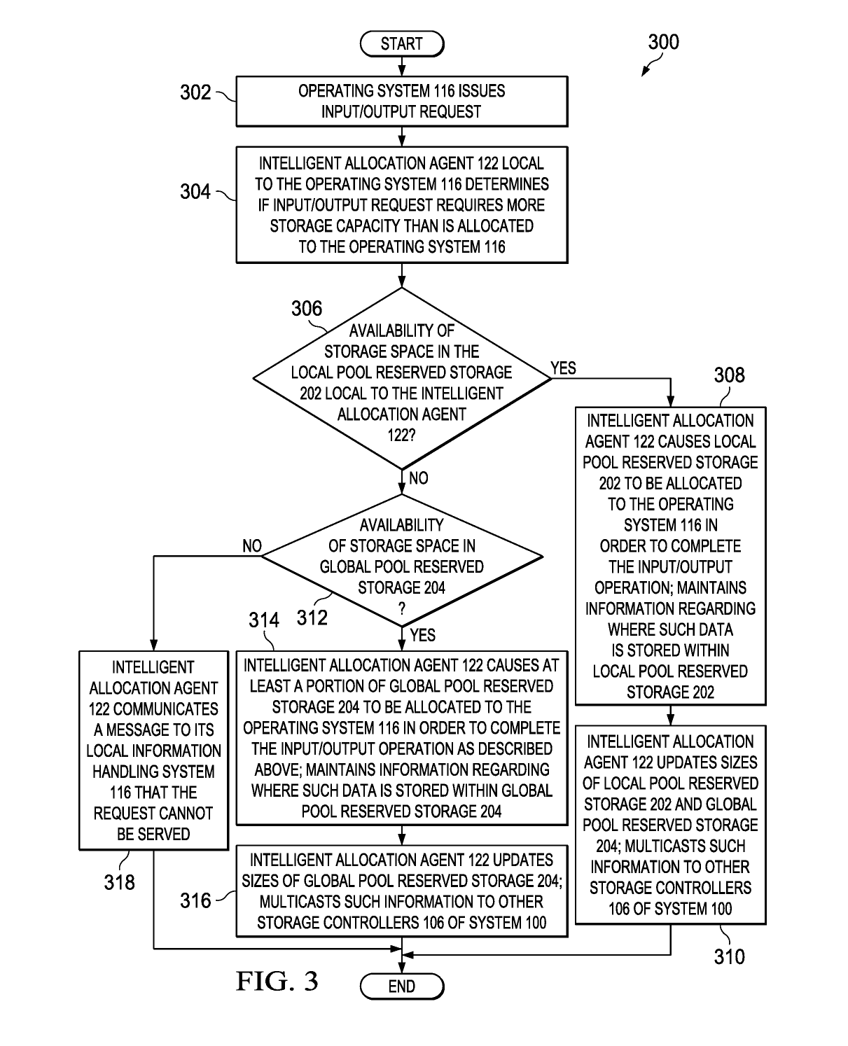

FIG. 3 illustrates a flow chart of an example method 300 for performing an input/output operation, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, an operating system 116 may issue an input/output request. At step 304, an intelligent allocation agent 122 local to the operating system 116 may determine if the input/output request requires more storage capacity than is allocated to the operating system 116. If the request does not require excess storage capacity, method 300 may end. Otherwise, if the request does require excess storage capacity, then method 300 may proceed to step 306.

At step 306, the intelligent allocation agent 122 may determine availability of storage space in the local pool reserved storage 202 local to the intelligent allocation agent 122. If storage space is available in the local pool reserved storage 202, method 300 may proceed to step 308. Otherwise, method 300 may proceed to step 312.

At step 308, in response to the availability of storage space in the local pool reserved storage 202 local to the intelligent allocation agent 122, the intelligent allocation agent 122 may cause at least a portion of the local pool reserved storage 202 to be allocated to the operating system 116 in order to complete the input/output operation, and maintain information regarding where such data is stored within local pool reserved storage 202. At step 310, intelligent allocation agent 122 may update the sizes of local pool reserved storage 202 and global pool reserved storage 204, and multicast such information to other storage controllers 106 of system 100. After completion of step 310, method 300 may end.

At step 312, in response to the unavailability of storage space in the local pool reserved storage 202 local to the intelligent allocation agent 122, the intelligent allocation agent 122 may determine availability of storage space in global pool reserved storage 204. If storage space is available in global pool reserved storage 204, method 300 may proceed to step 314. Otherwise, method 300 may proceed to step 318.

At step 314, in response to the availability of storage space in global pool reserved storage 204, the intelligent allocation agent 122 may cause at least a portion of global pool reserved storage 204 to be allocated to the operating system 116 in order to complete the input/output operation as described above, and maintain information regarding where such data is stored within global pool reserved storage 204. At step 316, intelligent allocation agent 122 may update the sizes of global pool reserved storage 204, and multicast such information to other storage controllers 106 of system 100. After completion of step 316, method 300 may end.

At step 318, in response to the unavailability of storage space in global pool reserved storage 204, the intelligent allocation agent 122 may communicate a message to its local information handling system 116 that the request cannot be served.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using system 100 or any other system operable to implement method 300. In certain embodiments, method 300 may be implemented partially or fully in software and/or firmware embodied in computer-readable media.

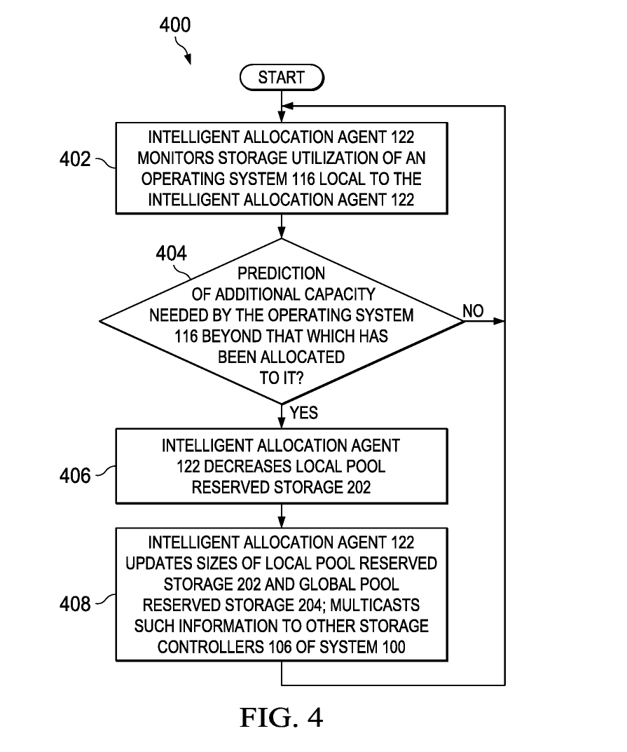

FIG. 4 illustrates a flow chart of an example method 400 for allocating local pool reserved storage 202 and global pool reserved storage 204 based on monitoring input/output requirements, in accordance with embodiments of the present disclosure. According to some embodiments, method 400 may begin at step 402. As noted above, teachings of the present disclosure may be implemented in a variety of configurations of information handling system 102. As such, the preferred initialization point for method 400 and the order of the steps comprising method 400 may depend on the implementation chosen.

At step 402, an intelligent allocation agent 122 may monitor the storage utilization of an operating system 116 local to the intelligent allocation agent 122. At step 404, intelligent allocation agent 122 may predict based on the monitoring if additional capacity may be needed by the operating system 116 beyond that which has been allocated to it. Such prediction may be made in any suitable manner (e.g., based on a rate of change of demand of capacity exceeding a particular rate). If intelligent allocation agent 122 predicts more capacity is required, method 400 may proceed to step 406. Otherwise, method 400 may proceed again to step 402.

At step 406, in response to intelligent allocation agent 122 predicting more capacity is required, intelligent allocation agent 122 may decrease local pool reserved storage 202 such that some capacity of local pool reserved storage 202 may be re-allocated to the capacity requirements of the local operating system 116.

At step 408, intelligent allocation agent 122 may update the sizes of local pool reserved storage 202 and global pool reserved storage 204, and multicast such information to other storage controllers 106 of system 100. After completion of step 408, method 400 may proceed again to step 402.

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using system 100 or any other system operable to implement method 400. In certain embodiments, method 400 may be implemented partially or fully in software and/or firmware embodied in computer-readable media.

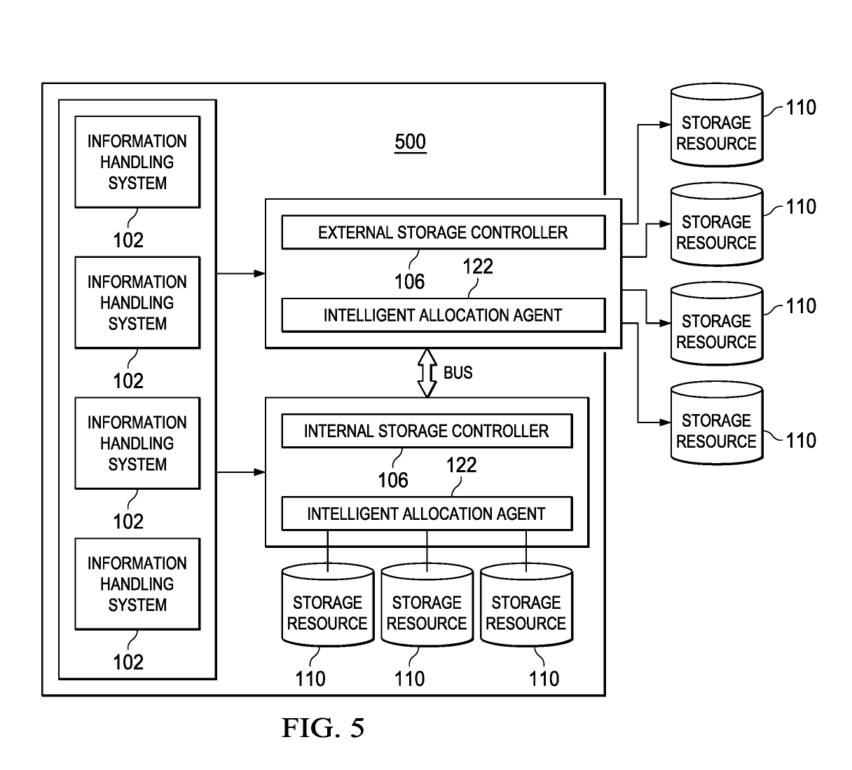

FIG. 5 illustrates a block diagram of a system of a plurality of information handling systems 102 in a converged architecture, in accordance with embodiments of the present disclosure. As used herein a “converged architecture” may be one in which a chassis 500 is configured with a plurality of slots, each slot for receiving a modular information handling system 102, wherein information handling resources of chassis 500 (e.g., storage controllers 106 and/or storage resources 110), may be shared among the modular information handling systems 102. For example, as shown in FIG. 5, internal storage controller 106 (depicted as controlling three storage resources 110 internal to chassis 500) and external storage controller 106 (depicted as controlling four storage resources 110 external to chassis 500) may be shared among the various modular information handling systems 102. Internal storage controller 106 and external storage controller 106 may be communicatively coupled to another via a Fibre Channel or other communication bus. Using systems and methods similar or identical to those set forth above, intelligent allocation agents 122 executing on storage controllers 106 may dynamically allocate storage between an internal storage controller 106 and an external storage controller 106 within the same chassis 500, or between a storage controller 106 (internal or external) of one chassis 500 and another storage controller 106 (internal or external) or another chassis 500 communicatively coupled to the first chassis.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system comprising:
a plurality of physical storage resources; and
a storage controller associated with the storage resources and configured to:
allocate a reserved portion of each of the plurality of physical storage resources to a local pool reserved storage associated with the storage controller;
communicate to at least one other storage controller information regarding the local pool reserved storage; and
receive from the at least one other storage controller information regarding a global pool reserved storage comprising the local pool reserved storage and at least one other local pool reserved storage of the at least one other storage controller.

2. The information handling system of claim 1, wherein the storage controller is further configured to, in response to an input/output request from an operating system of the information handling system:
determine if storage capacity of unreserved portions of the plurality of physical storage resources other than the reserved portions is sufficient to satisfy the input/output request; and
allocate one of the local pool reserved storage and the global pool reserved storage responsive to determining that the unreserved portions of the plurality of physical storage resources are insufficient to the input/output request.

3. The information handling system of claim 2, wherein the storage controller is further configured to maintain metadata regarding a physical storage location of data associated with the input/output request within the local pool reserved storage or the global pool reserved storage.

4. The information handling system of claim 2, wherein the storage controller is further configured to:
determine if storage capacity of the local pool reserved storage is sufficient to satisfy the input/output request; and
allocate local pool reserved storage responsive to determining that the local pool reserved storage is sufficient to satisfy the input/output request.

5. The information handling system of claim 4, wherein the storage controller is further configured to:
determine if storage capacity of the global pool reserved storage is sufficient to satisfy the input/output request responsive to determining that the local pool reserved storage is insufficient to satisfy the input/output request; and
allocate global pool reserved storage responsive to determining that the global pool reserved storage is sufficient to satisfy the input/output request.

6. The information handling system of claim 1, wherein the storage controller is further configured to:
monitor input/output activity of an operating system to the plurality of physical storage resources;
predict based on the input/output activity whether the operating system is likely to require storage capacity in addition to that allocated to the operating system; and
increase a reserved portion of at least one of the plurality of physical storage resources in order to increase a size of the local pool reserved storage.

7. The information handling system of claim 1, wherein the storage controller is further configured to communicate to the at least one other storage controller information regarding the increase in size of the local pool reserved storage.

8. A method comprising:
allocating a reserved portion of each of a plurality of physical storage resources of an information handling system to a local pool reserved storage associated with a storage controller of the information handling system;
communicating to at least one other storage controller information regarding the local pool reserved storage; and
receiving from the at least one other storage controller information regarding a global pool reserved storage comprising the local pool reserved storage and at least one other local pool reserved storage of the at least one other storage controller.

9. The method of claim 8, further comprising, in response to an input/output request from an operating system of the information handling system:
determining if storage capacity of unreserved portions of the plurality of physical storage resources other than the reserved portions is sufficient to satisfy the input/output request; and
allocating one of the local pool reserved storage and the global pool reserved storage responsive to determining that the unreserved portions of the plurality of physical storage resources are insufficient to the input/output request.

10. The method of claim 9, further comprising maintaining metadata regarding a physical storage location of data associated with the input/output request within the local pool reserved storage or the global pool reserved storage.

11. The method of claim 9, further comprising:
determining if storage capacity of the local pool reserved storage is sufficient to satisfy the input/output request; and
allocating local pool reserved storage responsive to determining that the local pool reserved storage is sufficient to satisfy the input/output request.

12. The method of claim 11, further comprising:
determining if storage capacity of the global pool reserved storage is sufficient to satisfy the input/output request responsive to determining that the local pool reserved storage is insufficient to satisfy the input/output request; and
allocating global pool reserved storage responsive to determining that the global pool reserved storage is sufficient to satisfy the input/output request.

13. The method of claim 8, further comprising:
monitoring input/output activity of an operating system to the plurality of physical storage resources;
predicting based on the input/output activity whether the operating system is likely to require storage capacity in addition to that allocated to the operating system; and
increasing a reserved portion of at least one of the plurality of physical storage resources in order to increase a size of the local pool reserved storage.

14. The method of claim 8, further comprising communicating to the at least one other storage controller information regarding the increase in size of the local pool reserved storage.

15. An article of manufacture comprising:
a non-transitory computer-readable medium; and
computer-executable instructions carried on the computer-readable medium, the instructions readable by a processor, the instructions, when read and executed, for causing the processor to:
allocate a reserved portion of each of a plurality of physical storage resources of an information handling system to a local pool reserved storage associated with a storage controller of the information handling system;
communicate to at least one other storage controller information regarding the local pool reserved storage; and
receive from the at least one other storage controller information regarding a global pool reserved storage comprising the local pool reserved storage and at least one other local pool reserved storage of the at least one other storage controller.

16. The article of claim 15, the instructions for further causing the processor to, in response to an input/output request from an operating system of the information handling system:
determine if storage capacity of unreserved portions of the plurality of physical storage resources other than the reserved portions is sufficient to satisfy the input/output request; and
allocate one of the local pool reserved storage and the global pool reserved storage responsive to determining that the unreserved portions of the plurality of physical storage resources are insufficient to the input/output request.

17. The article of claim 16, the instructions for further causing the processor to maintain metadata regarding a physical storage location of data associated with the input/output request within the local pool reserved storage or the global pool reserved storage.

18. The article of claim 16, the instructions for further causing the processor to:
determine if storage capacity of the local pool reserved storage is sufficient to satisfy the input/output request; and
allocate local pool reserved storage responsive to determining that the local pool reserved storage is sufficient to satisfy the input/output request.

19. The article of claim 18, the instructions for further causing the processor to:
determine if storage capacity of the global pool reserved storage is sufficient to satisfy the input/output request responsive to determining that the local pool reserved storage is insufficient to satisfy the input/output request; and
allocate global pool reserved storage responsive to determining that the global pool reserved storage is sufficient to satisfy the input/output request.

20. The article of claim 15, the instructions for further causing the processor to:
monitor input/output activity of an operating system to the plurality of physical storage resources;
predict based on the input/output activity whether the operating system is likely to require storage capacity in addition to that allocated to the operating system; and
increase a reserved portion of at least one of the plurality of physical storage resources in order to increase a size of the local pool reserved storage.

21. The article of claim 20, the instructions for further causing the processor to communicate to the at least one other storage controller information regarding the increase in size of the local pool reserved storage.
